(19) United States
(12) Patent Application Publication
(10) Pub. No.: US 2020/0060012 A1
(43) Pub. Date: Feb. 20, 2020

(54) Portable Static Reducer

(71) Applicant: Dan Robert Weber, HOLIDAY ISLAND, AR (US)

(72) Inventor: Dan Robert Weber, HOLIDAY ISLAND, AR (US)

(21) Appl. No.: 16/104,949

(22) Filed: Aug. 19, 2018

(51) Int. Cl. H05F 3/04; H05F 1/00

(52) U.S. Cl. CPC H05F 3/04; D10B 2401/16; H05F 1/00

(57) ABSTRACT

The present invention relates to reducing static electricity in the general populations clothing, as well as but not limited to, static electricity shock between a person and metal. The present invention consists of a protective material or tubing (1a and 2a) shaped to protect a Resistor (1b and 2b). Metal attachments or Metal Screws (1c and 2c) are attached to said Protective Material and to said Resistor (1b and 2b). The static electricity flows from the screws, to the resistor, neutralizing the static shock to the person. The same neutralizing capability reduces static electricity in clothing. The static electricity flows from the clothing to the resistor, neutralizing the static charge.

### BACKGROUND OF THE INVENTION

The present invention relates to solving the problem of static cling on clothes, as well as but not limited to, eliminating static electrical shock between a person and a metal object. The present invention is reusable and portable.

### BRIEF SUMMARY OF THE INVENTION

The general population has limited ways to reduce static electricity. The present invention reduces the amount of static electricity inside a dryer, and on clothing inside the dryer, by reducing static as it tumbles inside a dryer. The invention does not leave any residue in the dryer or on clothing, unlike a dryer sheet. The present invention is portable, and can also be used while the article of clothing is being worn, or hanging on a clothes hanger. The portability of the present invention also gives it another use; attaching a metal support such as a key ring, the person holding the invention can transfer static electricity off of them, and eliminate static electricity shock.

### BRIEF DESCRIPTION OF DRAWINGS

FIG. 1—The figure is a drawing of the portable static reducer for a clothes dryer. It has three parts.
1a—Tubing, or other protective material that protects the static reducing element.
1b—Resistor that reduces static electricity
1c—a metal screw or any metal that attached to the tubing on both ends

FIG. 2—The figure is a drawing of the Portable Static Reducer for static electricity shock reduction to the general population. It has four parts.

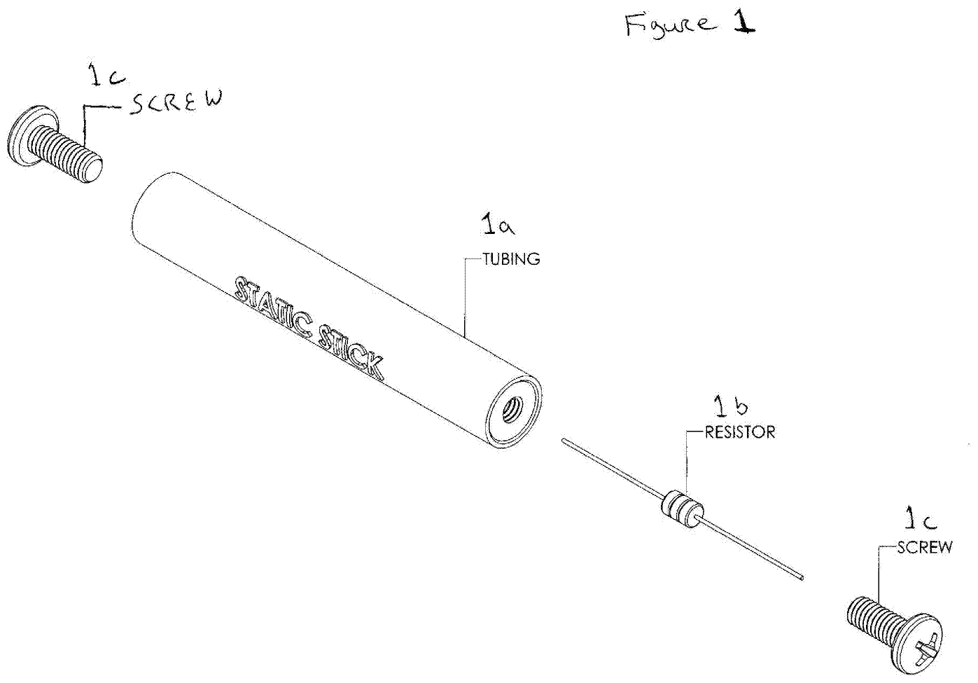

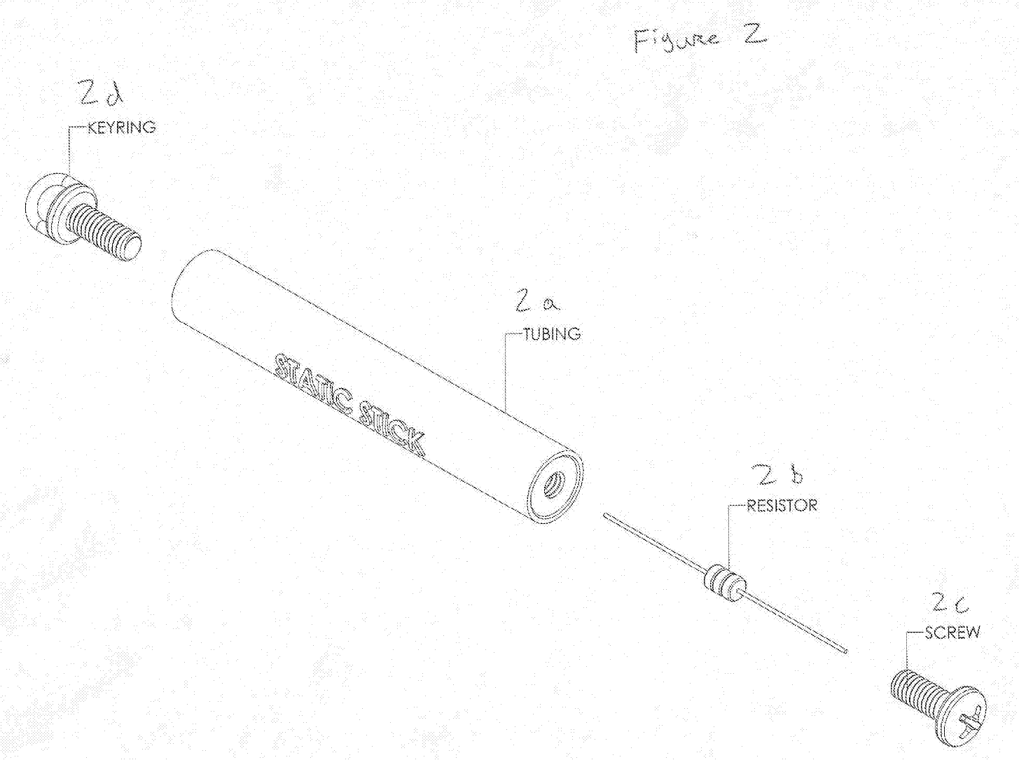

2a—Tubing, or other protective material that protects the static reducing element.
2b—Resistor that reduces static electricity
2c—a metal screw or any metal that attached to the tubing on both ends
2d—a keyring or metal support large enough to hold with fingers

### DETAILED DESCRIPTION OF THE INVENTION

The present invention reduces static electricity in many use cases. The first of note is static cling on clothing. The second is static electrical shock. The linchpin of the present invention is the resistor (1b and 2b). Resistors (1b and 2b) are currently used in many consumer products such as in computers, toasters, radios, and phones to regulate the flow of electricity. They protect the user from the devices electrical current, as well as the device itself. The present invention uses the electrical protection of the resistor, and applies it to, but not limited to, static cling and static electrical shock. However, resistors (1b and 2b) are easily malleable and are not weather resistant. The present invention uses a tubing (1a and 2a) to protect the resistor from the elements and the user. The tubing (1a and 2a) can be round, square, or any shape; in which the purpose is to not expose the resistor to the elements. Metal screws (1c and 2c) or any metal that attaches to the tubing and the resistor, are attached to the tubing, and connected to the resistor giving the invention a larger surface area for static to reach the resistor. Once the static electricity reaches the resistor (1a and 2b), the electrical current is reduced by said Resistor.

Static cling on clothes is currently dependent on the dryer sheet; however dryer sheets have limitations. Dryer sheets are not reusable, not recyclable, and coats a film on clothes and the dryer, that can reduce the function of active wear, flame retardant clothing, and the dryer itself. The present invention does not have these limitations. The Portable Static Reducer is designed to be placed into the dryer with clothes on the drying cycle. The clothes will interact with the metal ends or screws (1c) sending the electrical current to the resistor (1b). The resistor will reduce the electrical current to a lesser amount. The high heat tubing (1a and 2a) protects the resistor during this process as it repeats itself, reducing the amount of static on the clothing. The portability of the invention allows the user to reduce static while wearing clothing, or while clothes are on a hanger. The steps are to hold the Portable Static Reducer by its tubing (1a), then rub the metal end (1c) along the static clothing. The static electricity will transfer from the clothing to the metal screw (1c) to the resistor (1a). The resistor will reduce the static charge from the metal screw. No other products allow for instant static reduction while the articles of clothing are worn.

When a person touches a door knob, car door handle, or water fountain and receives a surprising electrical shock, it's not a pleasant experience. The reason for the shock is the body built up an uneven amount of protons or electrons, and found a metal object to cancel out the extra atoms in the body, in a very unpleasant way, a shock. Some people can shock themselves several times a day, and would prefer to not have this happen again. The present invention can reduce this problem. The resistor (1b and 2b) inside the tubing is designed to cancel out variances in electrical currents. The real problem is not the door knob, it's the person. The reason the present invention works is the person holding the invention is oversupplied of one particular atom. The key is to follow the proper steps to ensure neutralization. First, a person holds the key ring (2d) at the end of the Portable Static Reducer. Second, while holding the key ring (2d) end, they touch anything metal, this neutralizes the body. A neutral body is not as susceptible to shock. The final step is the person touches the metal object. The science behind the neutralization is the resistor (1b and 2b), it has the ability to complete the circuit of too many protons or electrons in the body, without relaying back a harmful amount of static electricity.

1. A Portable Static Reducer comprising of:
a. Protective material shaped to protect the Resistor (1b and 2b). Example plastic Tubing (1a and 2a)
b. Resistor (1b and 2b) inserted into said Tubing or protective material (1a and 2a).
c. Metal attachments an example Metal Screws (1c and 2c) attached or close enough, to said protective material or Tubing (1a and 2a) and attached or close enough, to said Resistor (1b and 2b) to reduce static electricity

2. that the said Resistor (1b and 2b), said Protective material or Tubing (1a and 2a), and said Metal Attachments an example Metal Screws (1c and 2c), Attach to each other, or are close enough to transfer Static Electricity.

3. that the Metal Attachments or Metal Screws (1c and 2c) transfer static electricity from an animate or inanimate object to the said Metal Attachments (1c and 2c)

4. the static electricity from Metal Attachments an example Metal Screws (1c and 2c) transfers into said Resistor (1b and 2b),

5. the said Resistor (1b and 2b) reduces or eliminates static electricity in the animate or inanimate object, and surrounding area.

6. the said Resistor (1b and 2b) is protected from the environment by said Protective material or Tubing (1a and 2a)

7. the said invention can be used but not limited to reducing static electricity and cling on clothing, or also in a clothes dryer. It is portable and therefore can be used while clothes are worn or hanging on a hanger.

8. the said invention can reduce static electricity and or shock between animate and inanimate objects, or any variation of living and non living things, to include inanimate objects, in particular static electrical shock between a person and metal.
